(19) United States
(12) Patent Application Publication
(10) Pub. No.: US 2017/0184707 A1
(43) Pub. Date: Jun. 29, 2017

(54) OPTICAL COMPONENT

(71) Applicant: DENSO CORPORATION, Kariya-city, Aichi-pref. (JP)

(72) Inventors: Makiko SUGIURA, Kariya-city (JP); Shuichi YAMASHITA, Kariya-city (JP); Naohisa NIIMI, Kariya-city (JP)

(21) Appl. No.: 15/313,118

(22) PCT Filed: Sep. 17, 2015
(86) PCT No.: PCT/JP2015/004759

§ 371 Date: Nov. 22, 2016

(30) Foreign Application Priority Data
Sep. 24, 2014 (JP) 2014-194307

(51) Int. Cl. G01S 7/481; G01S 17/08

(52) U.S. Cl. CPC G01S 7/4817; G01S 17/08

(57) ABSTRACT

An optical component for reflecting incident light at a predetermined reflection angle, includes: a scan portion having a reflection surface and scanning the reflection angle; and a package accommodating the scan portion, and having a main body of a box shape with one open surface and a lid which covers the one open surface and transmits the incident light and reflected light. The lid includes at least one base portion having a counter surface facing the reflection surface and a back surface opposed to the counter surface, and a diffraction lens portion arranged on at least one of the counter surface and the back surface and having a periodic concavo-convex shape so as to widen the reflection angle.

### CROSS REFERENCE TO RELATED APPLICATION

This application is based on Japanese Patent Application No. 2014-194307 filed on Sep. 24, 2014, the disclosure of which is incorporated herein by reference.

### TECHNICAL FIELD

The present disclosure relates to an optical component reflecting incident light at a predetermined reflection angle.

### BACKGROUND ART

A distance measuring device measuring a distance to an object is disclosed in Patent Literature 1. The distance measuring device includes a laser diode, a MEMS mirror, and a scan angle magnifying lens. The MEMS mirror reflects a laser beam emitted from the laser diode at a predetermined mirror angle. The scan angle magnifying lens widens a scan angle of the laser beam reflected on the MEMS mirror.

The distance measuring device configured as above is provided with a package to house the MEMS mirror in an internal space with the aim of protecting the MEMS mirror. However, when configured in such a manner, the package and the scan angle magnifying lens are provided separately. Consequently, an installation space is increased and the distance measuring device may possibly be increased in size.

### PRIOR ART LITERATURES

### Patent Literature

Patent Literature 1: JP-2014-20963 A

### SUMMARY OF INVENTION

It is an object of the present disclosure to provide an optical component, a size of which can be reduced while widening a refection angle.

According to an aspect of the present disclosure, an optical component for reflecting incident light at a predetermined reflection angle, includes: a scan portion having a reflection surface on which the incident light is reflected and scanning the reflection angle; and a package accommodating the scan portion in an internal space thereof, and having a main body of a box shape with one open surface and a lid which covers the one open surface and transmits the incident light and reflected light reflected by the scan portion. The lid includes at least one base portion having a counter surface facing the reflection surface and a back surface opposed to the counter surface, and a diffraction lens portion arranged on at least one of the counter surface and the back surface and having a periodic concavo-convex shape so as to widen the reflection angle.

In the configuration as above, the diffraction lens portion widening a reflection angle is provided to the lid portion of the package on at least one of the counter surface and the back surface of the base portion. In short, the diffraction lens portion is formed as a part of the lid portion. Hence, in comparison with a configuration in which the package and the diffraction lens portion are provided separately, an installation space of the diffraction lens portion can be reduced. Consequently, a size of the optical component can be reduced while widening a reflection angle by the diffraction lens portion.

Also, in the configuration as above, the lid portion has the diffraction lens portion formed in a concavo-convex shape as a lens widening a reflection angle. Hence, the lid portion can be thinner in comparison with a configuration in which the lid portion has a lens (Fresnel lens or the like) different from the diffraction lens portion. Consequently, a size of the optical component can be reduced.

### BRIEF DESCRIPTION OF DRAWINGS

The above and other objects, features and advantages of the present disclosure will become more apparent from the following detailed description made with reference to the accompanying drawings. In the drawings:

FIG. 1 is a side view showing a schematic configuration of a distance measuring device according to a first embodiment;

FIG. 2 is a top view showing a detailed structure of a lid portion;

FIG. 3 is a sectional view taken along the line III-III of FIG. 2;

FIG. 4 is a sectional view showing a detailed structure of an optical component according to a second embodiment;

FIG. 5 is a sectional view showing a detailed structure of an optical component according to a third embodiment;

FIG. 6 is a sectional view showing a detailed structure of an optical component according to a first modification;

FIG. 7 is a sectional view showing a detailed structure of an optical component according to a fourth embodiment;

FIG. 8 is a sectional view showing a detailed structure of an optical component according to a second modification;

FIG. 9 is a sectional view showing a detailed structure of an optical component according to a third modification;

FIG. 10 is a top view showing a detailed structure of a lid portion according to a fifth embodiment;

FIG. 11 is a sectional view showing a detailed structure of an optical component according to a fourth modification; and

FIG. 12 is a sectional view showing a detailed structure of an optical component according to a fifth modification.

### EMBODIMENTS FOR CARRYING OUT INVENTION

Hereinafter, embodiments of the present disclosure will be described with reference to the drawings. In the respective embodiments described below, common or related elements are labeled with same reference numerals. In a bottom portion of a main body portion, a direction orthogonal to one surface is given as a Z direction, a particular direction orthogonal to the Z direction is given as an X direction, and a direction orthogonal to both of the Z direction and the X direction is given as a Y direction. A plane defined by the X direction and the Y direction is given as an X-Y plane. A shape conforming to the X-Y plane is given as a planar shape. In top views of FIG. 2 and FIG. 10, convex portions in a diffraction lens portion are shaded to clearly indicate a planar shape of the convex portions.

### First Embodiment

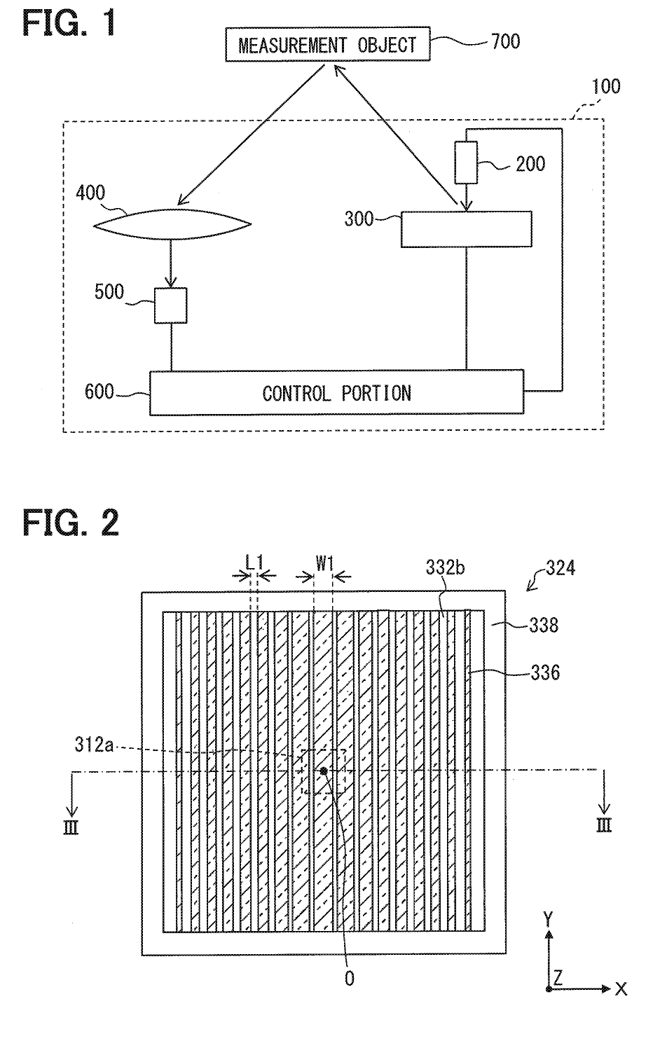

An optical component 300 of the present embodiment is applied to a distance measuring device 100 and a schematic configuration of the distance measuring device 100 will be described first according to FIG. 1.

The distance measuring device 100 is a device measuring a distance from the distance measuring device 100 to a measurement object 700. The distance measuring device 100 includes a laser 200, the optical component 300, a light-receiving lens 400, a light-receiving element 500, and a control portion 600. The distance measuring device 100 can be, for example, a vehicle laser radar measuring a distance between an own vehicle and a vehicle ahead.

The laser 200 is a light source which emits laser light. The laser 200 can be, for example, a light source which emits laser light at a wavelength of 800 to 900 nm. In the present embodiment, the laser 200 emits polarized light as laser light. The laser light enters the optical component 300.

The optical component 300 is a component which reflects the laser light entering the optical component 300 at a predetermined reflection angle. The laser light reflected by the optical component 300 is emitted to a measurable range of the distance measuring device 100 and reflected on the measurement object 700 located within the measurable range. The laser light reflected on the measurement object 700 enters the light-receiving lens 400. A detailed structure of the optical component 300 will be described below.

The light-receiving lens 400 is an optical member which gathers laser light reflected on the measurement object 700. The laser light gathered by the light-receiving lens 400 enters the light-receiving element 500. The light-receiving element 500 detects the laser light and outputs a detection signal to the control portion 600. The light-receiving element 500 can be, for example, a photo-diode.

The control portion 600 controls emission timing of laser light and intensity of laser light and also controls driving of a MEMS mirror 310 described below. In addition, the control portion 600 calculates a distance from the distance measuring device 100 to the measurement object 700 on the basis of emission timing of laser light and light-reception timing at the light-receiving element 500. The control portion 600 is connected to an unillustrated external device and outputs a signal generated on the basis of the distance thus calculated to the external device.

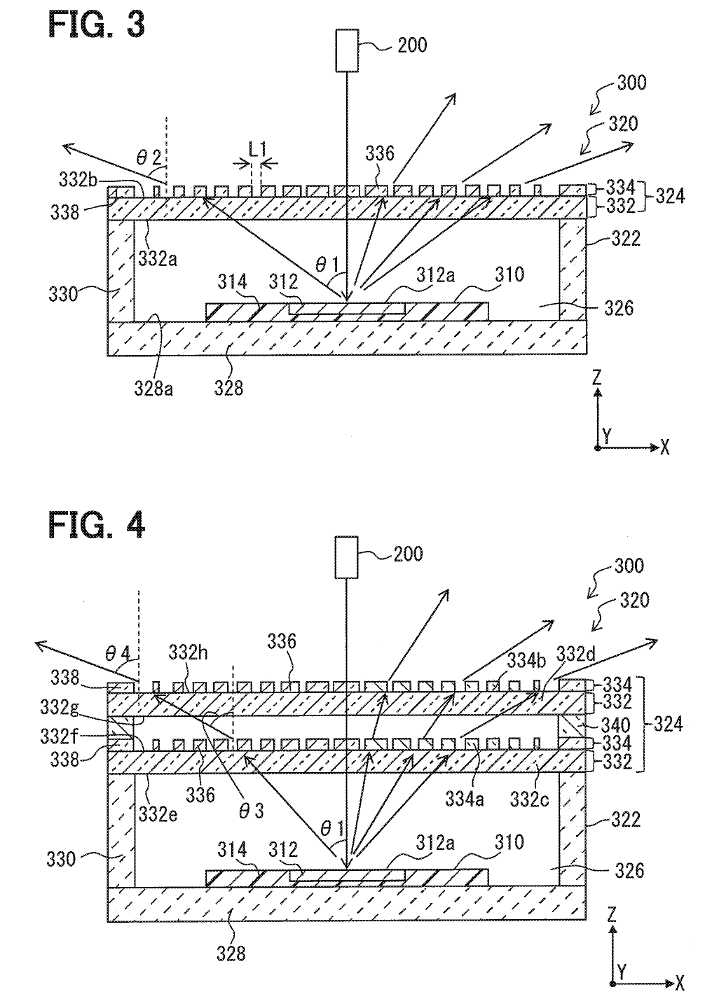

A detailed structure of the optical component 300 will now be described according to FIG. 2 and FIG. 3.

The optical component 300 includes the MEMS mirror 310 which scans laser light and a package 320 which houses the MEMS mirror 310 in an internal space 326. The MEMS mirror 310 corresponds to a scan portion.

The MEMS mirror 310 has a mirror portion 312 which reflects laser light and a support portion 314 on which the mirror portion 312 is supported. The mirror portion 312 has a reflection surface 312a on which laser light entering the optical component 300 is reflected. Hereinafter, laser light entering the optical component 300 is referred to also as the incident light. Likewise, laser light reflected on the reflection surface 312a is referred to also as the reflected light.

The mirror portion 312 is connected to the support portion 314 by an unillustrated connection portion. The connection portion is elastically deformable. In the present embodiment, the mirror portion 312 is allowed to rotate about the Y direction by the connection portion. The MEMS mirror 310 is of an electrostatically-actuated type driven by an electrostatic force. Each of the mirror portion 312 and the support portion 314 has an electrode. When a drive voltage is applied between the electrode of the mirror portion 312 and the electrode of the support portion 314, an electrostatic force is generated between the electrodes. In response to the electrostatic force, the connection portion undergoes elastic deformation and also the mirror portion 312 undergoes displacement with respect to the support portion 314.

A reflection angle θ1 at which the incident light is reflected on the reflection surface 312a is determined by an extent to which the mirror portion 312 undergoes displacement. The reflection angle θ1 is an angle that the reflected light produces with the Z direction. Multiple arrows of FIG. 3 represent the reflected light reflected on the reflection surface 312a at different timing. The control portion 600 controls an extent to which the mirror portion 312 undergoes displacement and hence the reflection angle θ1 by controlling magnitude of the drive voltage. The MEMS mirror 310 is housed in the internal space 326 of the package 320.

The package 320 has a main body portion 322 shaped like a box with one open surface and a lid portion 324 closing an opening of the main body portion 322. The main body portion 322 and the lid portion 324 together define the internal space 326 of the package 320. The internal space 326 is held in a vacuum state. Hence, in comparison with a configuration in which the internal space 326 is held at atmospheric pressure or above, the drive voltage of the MEMS mirror 310 can be restricted.

The main body portion 322 is made of, for example, a ceramic material. The main body portion 322 has a bottom portion 328 and a side wall portion 330. The bottom portion 328 is shaped like a plate parallel to the Z direction in a thickness direction. The MEMS mirror 310 is fixed to the bottom portion 328 on one surface 328a forming an inner surface of the package 320. Hereinafter, the Z direction pointing toward the MEMS mirror 310 from the bottom portion 328 is defined as a direction pointing upward and a direction opposite to the upward direction is defined as a direction pointing downward. The side wall portion 330 is provided to extend upward from an outer peripheral end of the bottom portion 328 and formed in a cylindrical shape. When viewed from the top, an inner peripheral surface and an outer peripheral surface of the side wall portion 330 are shaped like squares with a center of one square falling on a center of the other square. The lid portion 324 is fixed to the side wall portion 330 so as to close an opening of the side wall portion 330 on an opposite side to the bottom portion 328.

The lid portion 324 is made of a material capable of transmitting laser light. In the present embodiment, the lid portion 324 is made of glass. The lid portion 324 has a base portion 332 and a diffraction lens portion 334. The base portion 332 is shaped like a plate parallel to the Z direction in a thickness direction and has a counter surface 332a opposing the reflection surface 312a and a back surface 332b on an opposite side to the counter surface 332a. The counter surface 332a is a surface of the base portion 332 on a side of the MEMS mirror 310 in the Z direction.

The counter surface 332a and the back surface 332b are planes conforming to the X-Y plane. The counter surface 332a defines the internal space 326. The MEMS mirror 310 is fixed to the bottom portion 328 with a center of the reflection surface 312a falling on a center O of the back surface 332b on the X-Y plane. The diffraction lens portion 334 is provided to the back surface 332b.

The diffraction lens portion 334 widens a reflection angle of the reflected light. The diffraction lens portion 334 is formed in a periodic concavo-convex shape on the back surface 332b. To be more specific, the diffraction lens portion 334 has multiple convex portions 336 protruding upward from the back surface 332b. The convex portions 336 are provided across an entire range surrounded by the side wall portion 330 on the X-Y plane. The convex portions 336 correspond to convex portions.

The diffraction lens portion 334 has an outer peripheral portion 338 protruding upward from the back surface 332b at substantially a same location as the side wall portion 330 on the X-Y plane. The outer peripheral portion 338 is provided so as to surround the convex portions 336 on the X-Y plane.

As is shown in FIG. 2, a planar shape of the convex portions 336 is a rectangular shape parallel to the Y direction in a longer direction and parallel to the X direction in a shorter direction. The concavo-convex shape of the diffraction lens portion 334 is of a stripe pattern in which the multiple convex portions 336 are aligned in the X direction alone. More specifically, on the X-Y plane, the respective convex portions 336 connect to the outer peripheral portion 338 by extending in the Y direction from one inner peripheral end to the other inner peripheral end of the outer peripheral portion 338 in the Y direction. The outer peripheral portion 338 connected to the convex portions 336 serves to reinforce the convex portions 336.

A phase of laser light entering the diffraction lens portion 334 varies with a proportion of the convex portions 336 in a space above the back surface 332b. A proportion of the convex portions 336 in the back surface 332b is decreased with an increasing distance from the center O of the back surface 332b in the X direction. More specifically, a distance L1 between two adjacent convex portions 336 becomes longer as the convex portions 336 are located more distant from the center O in the X direction. Further, a width W1 of the convex portions 336 in the shorter direction of the planar shape is made narrower as the convex portions are located more distant from the center O in the X direction. One cycle of the concavo-convex shape, that is, a length as a sum of the width W1 and the distance L1 is shorter than a wavelength of the laser light.

Owing to the configuration as above, the diffraction lens portion 334 functions as a wide-angle lens as good as a convex les protruding upward. Because the diffraction lens portion 334 widens an angle of the reflected light, an outgoing angle θ2 of the laser light emitted from the diffraction lens portion 334 to an outside of the package 320, that is, a reflection angle of the optical component 300 is greater than the reflection angle θ1. The outgoing angle θ2 is an angle that the laser light emitted from the diffraction lens portion 334 to the outside of the package 320 produces with the Z direction. Hereinafter, the outgoing angle θ2 is referred to also as the reflection angle θ2.

The laser 200 emits laser light in a direction perpendicular to the back surface 332b, that is, the Z direction. The laser light enters the optical component 300 in the Z direction. Herein, a polarization direction of the incident light is the Y direction. Hence, the longer direction of the convex portions 336 and the polarization direction of the incident light are parallel to each other in the back surface 332b.

The laser light passes through the lid portion 324 and is reflected on the reflection surface 312a. The laser light travels straight in the Z direction from the lid portion 324 to the reflection surface 312a. The reflection surface 312a reflects the incident light striking the reflection surface 312a at the predetermined reflection angle θ1. The reflected light passes through the base portion 332 and enters the diffraction lens portion 334. The diffraction lens portion 334 diffracts the reflected light and emits the reflected light to the outside of the package 320 at the outgoing angle θ2.

The optical component 300 described above can be manufactured by, for example, a method as follows. That is, the lid portion 324 is formed first using a known nano-inprinting method. More specifically, a layer of an oxide film is formed on a surface of a glass substrate. A die having a concavo-convex pattern is pressed against the layer of the oxide film and the oxide film is allowed to cure. Accordingly, a concavo-convex pattern corresponding to the concavo-convex pattern of the die is provided to the glass substrate. The concavo-convex pattern thus provided corresponds to the diffraction lens portion 334. The lid portion 324 can be formed by dicing the glass substrate.

Subsequently, the MEMS mirror 310 is fixed to the bottom portion 328 of the main body portion 322 by bonding or the like. The lid portion 324 is disposed so as to close the opening of the main body portion 322 and fixed by bonding or the like. Consequently, the optical component 300 is formed.

An effect of the optical component 300 as above will now be described.

In the present embodiment, the diffraction lens portion 334 is provided to the lid portion 324 of the package 320 on the back surface 332b. In short, the diffraction lens portion 334 is formed as a part of the lid portion 324. Owing to the configuration as above, an installation space of the diffraction lens portion 334 can be reduced in comparison with a configuration in which the package 320 and the diffraction lens portion 334 are provided separately. The diffraction lens portion 334 widens the reflection angle θ1 to the reflection angle θ2 for the reflected light from the optical component 300. Consequently, a size of the optical component 300 can be reduced while widening a reflection angle of the reflected light by the diffraction lens portion 334.

In the present embodiment, the lid portion 324 has the diffraction lens portion 334 formed in a concavo-convex shape as a lens widening a reflection angle of the reflected light. Hence, the lid portion 324 can be thinner in comparison with a configuration in which the lid portion 324 has a lens (Fresnel lens or the like) different from the diffraction lens portion 334. Consequently, a size of the optical component 300 can be reduced.

In the present embodiment, the convex portions 336 on the back surface 332b are of a rectangular shape parallel to the polarization direction of the incident light in the longer direction of the convex portions 336. Accordingly, light in a polarization direction other than the polarization direction of the incident light is restricted from passing through the lid portion 324 by the diffraction lens portion 334. Ambient light is thus restricted from entering the internal space 326 of the package 320. Consequently, emission of light unwanted as the reflected light from the optical component 300 to the outside of the package 320 can be restricted.

### Second Embodiment

In the present embodiment, a description will not be repeated for portions common with the optical component 300 described in the first embodiment above.

As is shown in FIG. 4, a lid portion 324 has multiple base portions 332 each provided with a diffraction lens portion 334. The multiple base portions 332 are laminated in a Z direction. In the present embodiment, the lid portion 324 has the base portions 332 in two layers. More specifically, the lid portion 324 has a first base portion 332c located on a lower side and a second base portion 332d located on an upper side as the base portions 332 in two layers.

The first base portion 332c has a counter surface 332e opposing a reflection surface 312a and a back surface 332f on an opposite side to the counter surface 332e. The counter surface 332e is a surface of the first base portion 332c on a side of a MEMS mirror 310 in the Z direction. The first base portion 332c has a first diffraction lens portion 334a on the back surface 332f as the diffraction lens portion 334.

The second base portion 332d has a counter surface 332g opposing the back surface 332f and a back surface 332h on an opposite side to the counter surface 332g. The counter surface 332g is a surface of the second base portion 332d on a side of the MEMS mirror 310 in the Z direction. The second base portion 332d has a second diffraction lens portion 334b on the back surface 332h as the diffraction lens portion 334. The first base portion 332c and the second base portion 332d are of substantially a same planar shape and disposed in such a manner that respective outer peripheral ends are exactly aligned with each other on an X-Y plane.

The lid portion 324 has a spacer portion 340 disposed between the first base portion 332c and the second base portion 332d in the Z direction. The spacer portion 340 is disposed at substantially a same position as outer peripheral portions 338 of the respective diffraction lens portions 334a and 334b on the X-Y plane. The spacer portion 340 prevents convex portions 336 of the first diffraction lens portion 334a from making contact with the back surface 332h.

Laser light reflected on the refection surface 312a passes through the first base portion 332c and enters the first diffraction lens portion 334a. The first diffraction lens portion 334a diffracts the laser light and emits the laser light to the second base portion 332d at an outgoing angle θ3. The outgoing angle θ3 is an angle that the laser light emitted from the first diffraction lens portion 334a to the second base portion 332d produces with the Z direction. Because the first diffraction lens portion 334a widens a reflection angle of the reflected light, the outgoing angle θ3 is greater than a reflection angle θ1.

The laser light emitted from the first diffraction lens portion 334a passes through the second base portion 332d and enters the second diffraction lens portion 334b. The second diffraction lens portion 334b diffracts the laser light and emits the laser light to an outside of a package 320 at an outgoing angle θ4. The outgoing angle θ4 is an angle that the laser light emitted from the second diffraction lens portion 334b to the outside of the package 320 produces with the Z direction, that is, a reflection angle of an optical component 300. Hereinafter, the outgoing angle θ4 is referred to also as the reflection angle θ4. Because the second diffraction lens portion 334b widens a reflection angle of the reflected light, the outgoing angle θ4 is greater than the outgoing angle θ3.

In the present embodiment, the lid portion 324 has the multiple base portions 332 each provided with the diffraction lens portion 334 and the base portions 332 are laminated. Owing to the configuration as above, the reflected light passes through the respective diffraction lens portions 334a and 334b and a reflection angle of the reflected light is widened by the respective diffraction lens portions 334a and 334b. To be more specific, the respective diffraction lens portions 334a and 334b together change the reflection angle θ1 of the reflected light to the reflection angle θ4 which is greater than the reflection angle θ1. Hence, in comparison with a configuration in which the lid portion 324 has the base portion 332 in one layer, a reflection angle of the reflected light can be widened further.

### Third Embodiment

In the present embodiment, a description will not be repeated for portions common with the optical component 300 described in the first embodiment above.

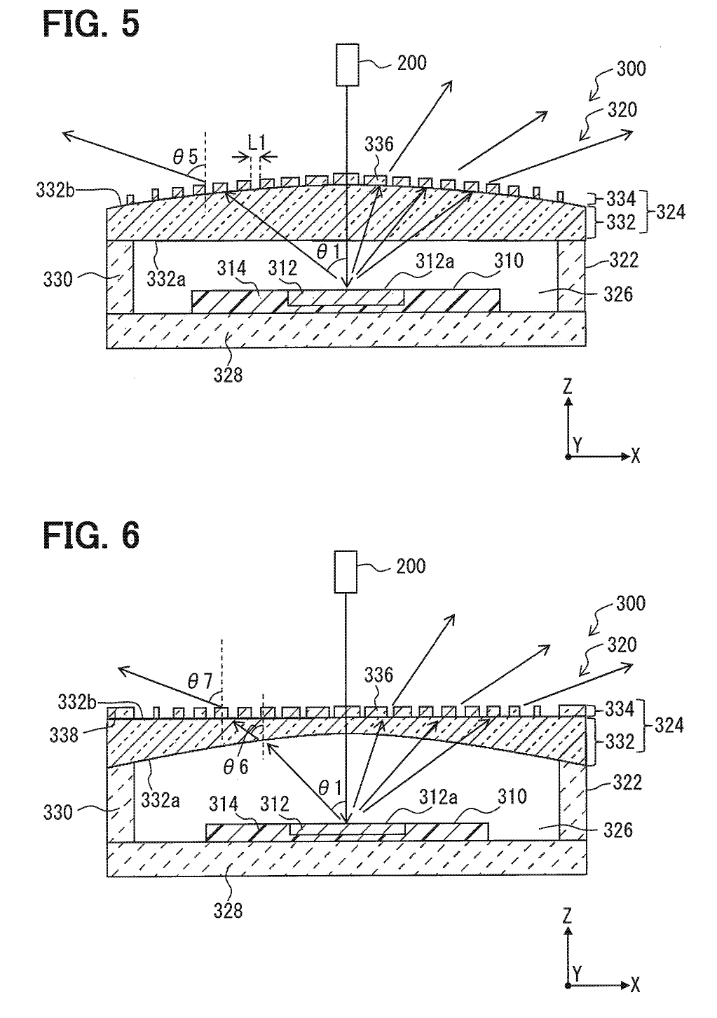

As is shown in FIG. 5, a back surface 332b is a convex curved surface protruding in a direction moving away from a MEMS mirror 310, that is, protruding upward so as to widen a reflection angle of reflected light. That is to say, the back surface 332b functions as a lens surface of a wide-angle lens widening a reflection angle of the reflected light. A lid portion 324 has a diffraction lens portion 334 on the back surface 332b. A counter surface 332a is a plane conforming to an X-Y plane.

Laser light reflected on a reflection surface 312a passes through the counter surface 332a and enters the back surface 332b. The reflected light is refracted by the back surface 332b and also diffracted by the diffraction lens portion 334 and emitted to an outside of a package 320 at an outgoing angle θ5. The outgoing angle θ5 is an angle that the laser light emitted from the diffraction lens portion 334 to the outside of the package 320 produces with a Z direction, that is, a reflection angle of an optical component 300. Hereinafter, the outgoing angle θ5 is referred to also as the reflection angle θ5.

Because the back surface 332b and the diffraction lens portion 334 widen a reflection angle of the reflected light, the outgoing angle θ5 is greater than a reflection angle θ1. As to the outgoing angle θ2 described in the first embodiment above and the outgoing angle θ5, given that the reflection angle θ1 is same, then the outgoing angle θ5 is greater than the outgoing angle θ2.

In the present embodiment, the back surface 332b is a convex curved surface protruding in a direction moving away from the MEMS mirror 310 so as to widen a reflection angle of the reflected light. Owing to the configuration as above, a reflection angle of the reflected light can be widened by the back surface 332b in addition to the diffraction lens portion 334. To be more specific, the back surface 332b and the diffraction lens portion 334 together change the reflection angle θ1 of the reflected light to the reflection angle θ5 which is greater than the reflection angle θ1. Consequently, a reflection angle of the reflected light can be widened further by the lid portion 324.

The present embodiment has described a case where the back surface 332b is an upward convex curved surface and the counter surface 332a is a plane conforming to the X-Y plane. It should be appreciated, however, that the present disclosure is not limited to the case described herein. As in a first modification shown in FIG. 6, the counter surface 332a may be a concave curved surface recessed in the direction moving away from the MEMS mirror 310 so as to widen a reflection angle. In the first modification, the lid portion 324 has the diffraction lens portion 334 on the back surface 332b alone. The back surface 332b is a plane conforming to the X-Y plane.

Laser light reflected on the reflection surface 312a enters the counter surface 332a. The counter surface 332a refracts the laser light and emits the laser light to the back surface 332b at an outgoing angle θ6. The outgoing angle θ6 is an angle that the laser light emitted from the counter surface 332a to the back surface 332b produces with the Z direction. Because the counter surface 332a widens a reflection angle of the reflected light, the outgoing angle θ6 is greater than the reflection angle θ1.

The diffraction lens portion 334 diffracts the laser light entering the back surface 332b and emits the laser light to the outside of the package 320 at an outgoing angle θ7. The outgoing angle θ7 is an angle that the laser light emitted from the diffraction lens portion 334 to the outside of the package 320 produces with the Z direction, that is, a reflection angle of the optical component 300. Hereinafter, the outgoing angle θ7 is referred to also as the reflection angle θ7. Because the diffraction lens portion 334 widens a reflection angle of the reflected light, the outgoing angle θ7 is greater than the outgoing angle θ6.

Owing to the configuration as above, a reflection angle of the reflected light can be widened by the counter surface 332a in addition to the diffraction lens portion 334. To be more specific, the counter surface 332a and the diffraction lens portion 334 together change the reflection angle θ1 of the reflected light to the reflection angle θ7 which is greater than the reflection angle θ1. Consequently, a reflection angle of the reflected light can be widened further by the lid portion 324.

### Fourth Embodiment

In the present embodiment, a description will not be repeated for portions common with the optical component 300 described in the first embodiment above.

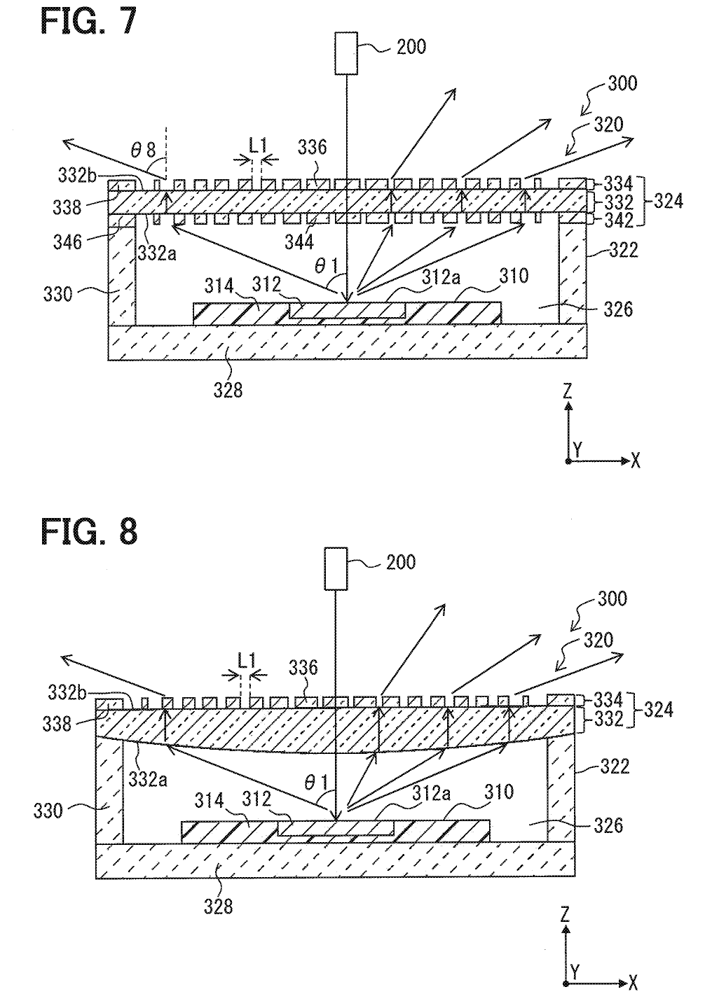

As is shown in FIG. 7, a lid portion 324 has a diffraction lens portion 334 on a back surface 332b. The lid portion 324 also has a collimate lens portion 342 changing reflected light to parallel light on a counter surface 332a.

The collimate lens portion 342 is formed in a periodic concavo-convex shape on the counter surface 332a. To be more specific, the diffraction lens portion 334 has multiple convex portions 344 protruding downward from the counter surface 332a. The convex portions 344 are provided across an entire range surround by a side wall portion 330 on an X-Y plane.

The diffraction lens portion 334 also has an outer peripheral portion 346 protruding downward from the counter surface 332a at substantially a same position as the side wall portion 330 on the X-Y plane. The outer peripheral portion 346 is provided so as to surround the convex portions 344 on the X-Y plane. The outer peripheral portion 346 serves to reinforce the convex portions 344 like an outer peripheral portion 338.

A phase of laser light entering the collimate lens portion 342 changes with a proportion of the convex portions 344 in a space below the counter surface 332a. A proportion of the convex portions 344 in the counter surface 332a is decreased with an increasing distance from a center of the counter surface 332a in an X direction. The collimate lens portion 342 thus functions as good as a collimate lens having a hyperboloid protruding downward. The collimate lens portion 342 is capable of changing reflected light to light parallel to a Z direction, no matter from which point the reflected light enters the collimate lens portion 342. That is to say, the counter surface 332a is capable of changing the reflected light to light parallel to the Z direction regardless of an incident angle at which the laser light enters the counter surface 332a.

Laser light reflected on a reflection surface 312a enters the collimate lens portion 342. The collimate lens portion 342 changes the laser light to light parallel to the Z direction, which is emitted to the back surface 332b. The diffraction lens portion 334 diffracts the light entering the back surface 332b and emits the light to an outside of a package 320 at an outgoing angle θ8. The outgoing angle θ8 is an angle that the laser light emitted from the diffraction lens portion 334 to the outside of the package 320 produces with the Z direction, that is, a reflection angle of an optical component 300. Because the diffraction lens portion 334 widens a reflection angle of the reflected light, the outgoing angle θ8 is greater than a reflection angle θ1.

In the present embodiment, the collimate lens portion 342 restricts diffusion of the laser light. Hence, because a beam diameter of the laser light striking a measurement object 700 can be smaller, resolution of a distance measuring device 100 can be enhanced.

The present embodiment has described a case where the lid portion 324 has the collimate lens portion 342. It should be appreciated, however, that the present disclosure is not limited to the case described herein. As in a second modification shown in FIG. 8, the counter surface 332a may be a convex curved surface protruding toward a MEMS mirror 310, that is, protruding downward so as to change the reflected light to parallel light. In the configuration as above, the diffraction lens portion 334 is provided to the back surface 332b alone.

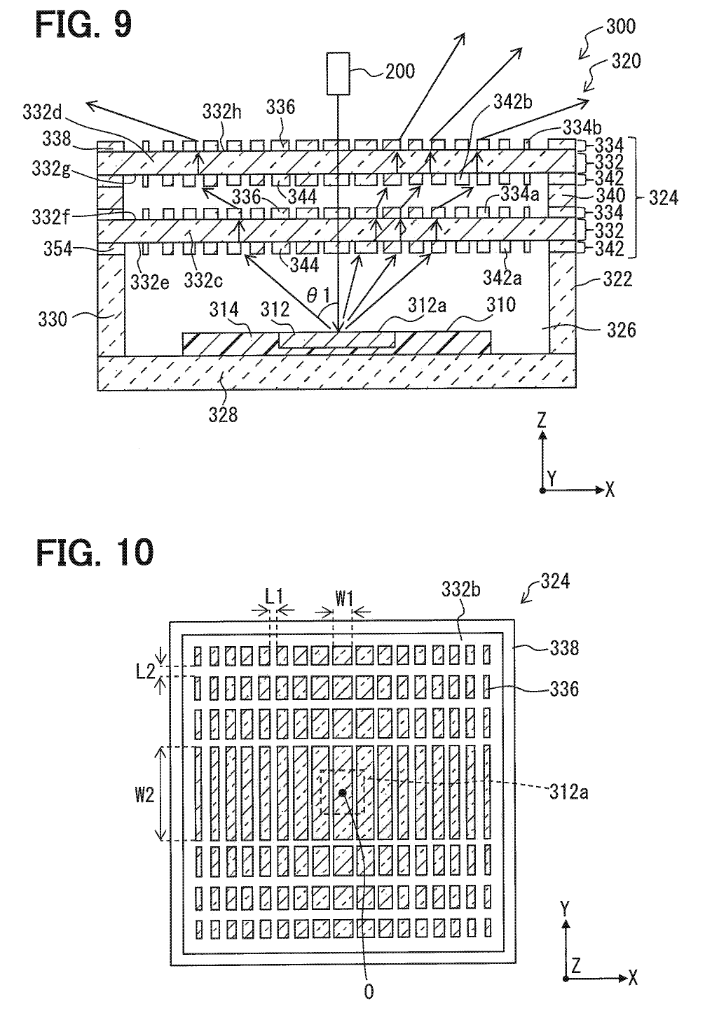

Also, the present embodiment has described a case where the lid portion 324 has a base portion 332 in one layer. It should be appreciated, however, that the present disclosure is not limited to the case described herein, either. As in a third modification shown in FIG. 9, the lid portion 324 may have multiple base portions 332 and each of base portions 332c and 332d may have the collimate lens portion 342. In the third modification, a first collimate lens portion 342a as the collimate lens portion 342 is provided to a counter surface 332e of the first base portion 332c. Also, a second collimate lens portion 342b as the collimate lens portion 342 is provided to a counter surface 332g of the second base portion 332d.

When configured as above, laser light reflected on the reflection surface 312a enters the counter surface 332e. The first collimate lens portion 342a changes the laser light entering the counter surface 332e to light parallel to the Z direction, which is emitted to a back surface 332f. The first diffraction lens portion 334a diffracts the laser light entering the back surface 332f and emits the laser light to the counter surface 332g. The second collimate lens portion 342b changes the laser light entering the counter surface 332g to light parallel to the Z direction, which is emitted to a back surface 332h. The second diffraction lens portion 334b diffracts the laser light entering the back surface 332h and emits the laser light to the outside of the package 320.

### Fifth Embodiment

In the present embodiment, a description will not be repeated for portions common with the optical component 300 described in the first embodiment above.

As is shown in FIG. 10, multiple convex portions 336 are disposed in a matrix fashion on a back surface 332b. The convex portions 336 are provided in such a manner that every two convex portions 336 adjacent in an X direction have a distance L1 from each other and every two convex portions 336 adjacent in a Y direction have a distance L2 from each other. A planar shape of the respective convex portions 336 is a rectangular shape with a longer direction aligned along the Y direction.

As in the first embodiment above, a proportion of the convex portions 336 in the back surface 332b is decreased with an increasing distance from a center O of the back surface 332b in the X direction. Further, in the present embodiment, a proportion of the convex portions 336 in the back surface 332b is decreased with an increasing distance from the center O in the Y direction. To be more specific, the distance L2 between the adjacent convex portions 336 becomes longer and a width W2 of the convex portions 336 in a longer direction of a planar shape is made narrower as the convex portions 336 are located more distant from the center O in the Y direction on the back surface 332b.

As in the first embodiment above, incident light is polarized light in a polarization direction parallel to the Y direction. Laser light reflected on a reflection surface 312a has an X component in a polarization direction parallel to the X direction and a Y component in a polarization direction parallel to the Y direction. In the laser light reflected on the reflection surface 312a and entering a diffraction lens portion 334, a ratio of the Y component and the X component varies with a reflection angle θ1. To be more specific, a ratio of the X component with respect to the Y component increases as the reflection angle θ1 becomes greater. Hence, in the laser light from the reflection surface 312a entering the back surface 332b in the vicinity of the center O, a ratio of the Y component with respect to the X component is high. On the other hand, in the laser light from the reflection surface 312a entering the back surface 332b at a position distant from the center O, a ratio of the Y component is low in comparison with the laser light entering in the vicinity of the center O.

It becomes easier for light in a polarization direction parallel to the X direction to pass through the diffraction lens portion 334 as the distance L2 becomes longer and the width W2 becomes narrower. As has been described, the distance L2 is set longer and the width W2 is set narrower as the convex portions 336 are located more distant from the center O of the back surface 332b in the Y direction on the back surface 332b. Consequently, even when laser light reflected at a large reflection angle θ1 is laser light in which a ratio of the Y component is low, the laser light passes through the diffraction lens portion 334 without decreasing intensity. Hence, a decrease in intensity of reflected light can be restricted while restricting emission of light unwanted as the reflected light from an optical component 300 to an outside of a package 320.

The present embodiment has described a case where a planar shape of the respective convex portions 336 is a rectangular shape with the longer direction aligned along the Y direction. It should be appreciated, however, that the present disclosure is not limited to the case describe herein. The present disclosure may adopt a case where a planar shape of the convex portions 336 is a rectangular shape with the longer direction aligned along the Y direction on the back surface 332b only within a range of a predetermined distance from the center O of the back surface 332b.

While preferred embodiments of the present disclosure have been described, it should be appreciated that the present disclosure is not particularly limited to the embodiments above and can be modified in various manners within the scope of the present disclosure.

The embodiments above have described a case where the optical component 300 is an element forming the distance measuring device 100. However, the present disclosure is not limited to the case described above. The optical component 300 may be used in a projector as well.

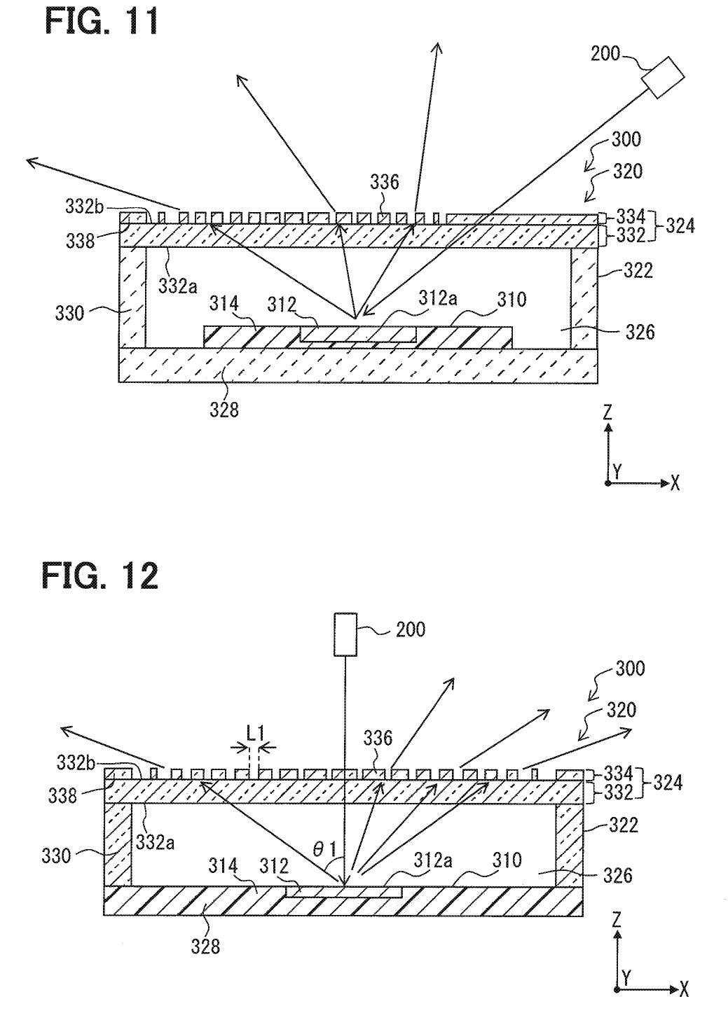

The embodiments above have described a case where incident light enters the optical component 300 in the Z direction which is perpendicular to the back surface 332b. However, the present disclosure is not limited to the case described above. As in a fourth modification shown in FIG. 11, the incident light may enter the back surface 332b at a predetermined angle with respect to the Z direction.

The embodiments above have described a case where the MEMS mirror 310 is fixed to the bottom portion 328 of the main body portion 322. However, the present disclosure is not limited to the case described above. As in a fifth modification shown in FIG. 12, the support portion 314 may form the bottom portion 328 of the package 320. When such a configuration is adopted, the optical component 300 may be manufactured by a method as follows.

Firstly, a glass substrate from which the lid portion 324 is formed and a wafer from which the MEMS mirror 310 is formed are prepared. Subsequently, the glass substrate and the wafer are bonded to each other via a glass frit functioning as a bonding material. The glass frit forms the side wall portion 330 of the package 320. Finally, the optical component 300 is formed by dicing the glass substrate and the wafer bonded together by one operation.

The embodiments above have described a case where incident light entering the optical component 300 is laser light emitted from the laser 200. However, the present disclosure is not limited to the case described above. The present disclosure may adopt a case where incident light entering the optical component 300 is light emitted from an LED. Also, the embodiments above have described a case where incident light is polarized light. However, the present disclosure is not limited to the case described above, either. The present embodiment may adopt a case where incident light is unpolarized light.

The embodiments above have described a case where the optical component 300 has the MEMS mirror 310 as a scan portion. However, the present disclosure is not limited to the case described above. The present disclosure may adopt a case where the optical component 300 has a polygonal mirror as the scan portion. Also, the embodiments above have described a case where the MEMS mirror 310 is of an electrically-actuated type. However, the present disclosure is not limited to the case described above, either. The MEMS mirror 310 may be of a piezoelectrically-actuated type provided with a piezoelectric thin film or an electromagnetically-actuated type in which a magnet is disposed.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

1. An optical component for reflecting incident light at a predetermined reflection angle, the optical component comprising:
a scan portion having a reflection surface on which the incident light is reflected and scanning the reflection angle; and
a package accommodating the scan portion in an internal space thereof, and having a main body of a box shape with one open surface and a lid which covers the one open surface and transmits the incident light and reflected light reflected by the scan portion, wherein:
the lid includes at least one base portion having a counter surface facing the reflection surface and a back surface opposed to the counter surface, and a diffraction lens portion arranged on at least one of the counter surface and the back surface and having a periodic concavo-convex shape so as to widen the reflection angle.

2. The optical component according to claim 1, wherein:
the at least one base portion includes a plurality of base portions;
the diffraction lens portion is arranged on each base portion; and
the lid is provided by the plurality of base portions stacked to each other.

3. The optical component according to claim 1, wherein:
polarized light enters the optical component as the incident light; and
a shape of a convex portion in the diffraction lens portion is a rectangular shape parallel to a polarization direction of the incident light in a longitudinal direction of the convex portion on the at least one of the counter surface and the back surface of the base portion where the diffraction lens portion is arranged.

4. The optical component according to claim 1, wherein:
the back surface of the base portion is a convex curved surface protruding in a direction moving away from the scan portion so as to widen the reflection angle.

5. The optical component according to claim 1, wherein:
the counter surface of the base portion is a concave curved surface recessed in a direction moving away from the scan portion so as to widen the reflection angle.

6. The optical component according to claim 1, wherein:
the lid has the diffraction lens portion on the back surface and a collimate lens portion on the counter surface, the collimate lens portion having a periodic concavo-convex shape so as to control the reflected light to be parallel light.

7. The optical component according to claim 1, wherein:
the base portion has the diffraction lens portion only on the back surface; and
the counter surface of the base portion is a convex curved surface protruding toward the scan portion so as to control the reflected light to be parallel light.
